(19) United States
(12) Patent Application Publication
(10) Pub. No.: US 2005/0173260 A1
(43) Pub. Date: Aug. 11, 2005

(54) System for electrochemical mechanical polishing

(76) Inventors: Bulent M. Basol, Manhattan Beach, CA (US); Homayoun Talieh, San Jose, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/069,202

(22) Filed: Feb. 28, 2005

Related U.S. Application Data
(63) Continuation-in-part of application No. 10/391,924, filed on Mar. 18, 2003.
(60) Provisional application No. 60/548,239, filed on Feb. 27, 2004.
(60) Provisional application No. 60/572,198, filed on May 18, 2004.

(51) Int. Cl. B23H 5/00

(52) U.S. Cl. 205/662

(57) ABSTRACT

A system for electrochemical mechanical polishing of a semiconductor wafer. The system includes a wafer carrier for holding the wafer, an electropolishing pad, and a showerhead for applying fluid towards the electrode. The electropolishing pad includes an electrode and a pad material layer attached to the electrode. The pad material layer includes openings to permit processing solution to wet both a conductive surface of the wafer and a surface of the electrode.

### RELATED APPLICATIONS

This application claims priority from U.S. Provisional Application No. 60/548,239, filed on Feb. 27, 2004 (NT-318 P) and U.S. Provisional Application No. 60/572,198, filed on May 18, 2004 (NT-318 P2).

This application is a continuation in part of U.S. patent application Ser. No. 10/391,924, filed Mar. 18, 2003 (NT-291).

This application is related to U.S. patent application Ser. No. 10/460,032, filed Jun. 11, 2003 (NT-200C1), which is a continuation of U.S. patent application Ser. No. 09/760,757, filed Jan. 17, 2001 (NT-200), now U.S. Pat. No. 6,610,190 issued Aug. 26, 2003.

This application is related to U.S. patent application Ser. No. 10/302,213, filed Nov. 22, 2002 (NT-105C1), which is a continuation of U.S. patent application Ser. No. 09/685,934 filed Oct. 11, 2000 (NT-105), now U.S. Pat. No. 6,497,800 issued Dec. 24, 2002.

This application is related to U.S. patent application Ser. No. 10/295,197, filed Nov. 15, 2002 (NT-217C2), which is a continuation of U.S. patent application Ser. No. 10/252,149, filed Sep. 20, 2002 (NT-217C1), now U.S. Pat. No. 6,604,998 issued Aug. 12, 2003, which is a continuation of U.S. patent application Ser. No. 09/880,730, filed Jun. 12, 2001 (NT-217), now U.S. Pat. No. 6,464,571 issued Oct. 15, 2002, which is a continuation in part of U.S. patent application Ser. No. 09/684,059, filed Oct. 6, 2000 (NT-002CIP), now U.S. Pat. No. 6,468,139 issued Oct. 22, 2002, which is a continuation in part of U.S. patent application Ser. No. 09/576,064, filed May 22, 2000 (NT-002C), now U.S. Pat. No. 6,207,572 issued Mar. 27, 2001, which is a continuation of U.S. patent application Ser. No. 09/201,928, filed Dec. 1, 1998 (NT-002), now U.S. Pat. No. 6,103,628 issued Aug. 15, 2000.

This application is related to U.S. patent application Ser. No. 10/292,750, filed on Nov. 12, 2002 (NT-001C2), which is a continuation of U.S. patent application Ser. No. 09/607,567 filed Jun. 29, 2000 (NT-001D), now U.S. Pat. No. 6,678,822 issued Jan. 13, 2004, which is a divisional of U.S. patent application Ser. No. 09/201,929, filed Dec. 1, 1998 (NT-001), now U.S. Pat. No. 6,176,992 issued Jan. 23, 2001.

This application is related to U.S. patent application Ser. No. 10/288,558, filed on Nov. 4, 2002 (NT-234).

This application is related to U.S. patent application Ser. No. 10/282,930, filed Oct. 28, 2002 (NT-215C1).

This application is related to U.S. patent application Ser. No. 10/152,793, filed on May 23, 2002 (NT-102D), which is a divisional of U.S. patent application Ser. No. 09/511,278 filed on Feb. 23, 2000 (NT-102), now U.S. Pat. No. 6,413,388 issued Jul. 2, 2002.

This application is related to U.S. patent application Ser. No. 10/117,991, filed on Apr. 5, 2002 (NT-214), now U.S. Pat. No. 6,821,409 issued Nov. 23, 2004.

This application is related to U.S. patent application Ser. No. 09/960,236, filed Sep. 20, 2001 (NT-209). The foregoing patent applications and patents are all hereby incorporated herein by reference in their entireties.

### FIELD

The present invention generally relates to semiconductor integrated circuit technology and, more particularly, to an electropolishing or electroetching process and apparatus.

### BACKGROUND

Conventional semiconductor devices generally include a semiconductor substrate, usually a silicon substrate, and a plurality of sequentially formed dielectric layers and conductive paths or interconnects made of conductive materials. Interconnects are usually formed by filling a conductive material in trenches etched into the dielectric layers. In an integrated circuit, multiple levels of interconnect networks laterally extend with respect to the substrate surface. Interconnects formed in different layers can be electrically connected using vias or contacts.

The filling of a conductive material into features such as vias, trenches, pads or contacts, can be carried out by electrodeposition. In electrodeposition or electroplating methods, a conductive material, such as copper, is deposited over the substrate surface, including into such features. Then, a material removal technique is employed to planarize and remove the excess metal from the top surface, leaving the conductive material only in the features or cavities. The standard material removal technique that is most commonly used for this purpose is chemical mechanical polishing (CMP). Chemical etching, electropolishing, which is also referred to as electroetching or electrochemical etching, and electrochemical mechanical polishing or etching are also attractive process options for copper removal. Copper is the material of choice, at this time, for interconnect applications because of its low resistivity and good electromigration properties.

Standard electroplating techniques yield copper layers that can be deposited conformally over large features, such as features with widths larger than a few micrometers, which results in a plated wafer surface topography that is not flat. FIG. 1 shows an exemplary structure after the copper plating step. The substrate 10 includes small features 12, such as high aspect ratio trenches, and large features or trenches 14. The features 12, 14 are formed in a dielectric layer 16. The substrate 10 is an exemplary portion of a partially fabricated integrated circuit over a semiconductor wafer. The dielectric layer 16 has a top surface 18. The features and the surface 18 of the dielectric are coated with a barrier/glue or adhesion layer 20 and a copper seed layer 22 prior to deposition of copper. The barrier layer 20 may be made of Ta, TaN or combinations of any other materials that are commonly used as barriers to copper diffusion. The seed layer 22 is deposited over the barrier layer 20, although for specially designed barrier layers, there may not be a need for a seed layer. After depositing the seed layer 22, copper is electrodeposited thereon from a suitable plating bath to form the copper layer 24.

During removal of the excess copper, employing CMP, etching or electropolishing, the non-flat surface topography of the copper layer 24 is planarized as the excess conductor is removed from the surface, leaving the conductor only within the features with a flat top surface. As described above, standard electroplating techniques yield conformal deposits over large features, resulting in non-planar workpiece surfaces that need to be planarized during the excess material removal step. Conventional planarization techniques tend to result in “dishing” or other non-uniformities when starting with the non-planar copper layer 24 of FIG. 1.

Newly developed electrodeposition techniques, which are collectively called Electrochemical Mechanical Deposition (ECMD) methods, utilize a WSID (workpiece surface influencing device), such as a pad, a polishing pad, a mask or a sweeper in close proximity of the wafer surface during conductor deposition. An exemplary ECMD process and tool therefor are described in U.S. Pat. No. 6,176,992, the disclosure of which is incorporated herein by reference. The action of the WSID during plating results in planar deposits with flat surface topography even over the largest features on the workpiece surface. The top surface of such a planar deposit is represented by the dotted line 26 in FIG. 1. Removal of excess conductive material, such as copper, from such planar deposits does not require further planarization during the material removal step. Therefore, CMP, electropolishing or electroetching, chemical etching, and electrochemical mechanical polishing techniques may all be successfully employed for removing the excess material in a planar and uniform manner in this case.

Although much progress has been made in electropolishing approaches and apparatuses, there is still a need for electrochemical removal techniques that uniformly planarize and remove excess conductive films from workpiece surfaces applying low force on the surface and without causing damage and defects, especially on advanced wafers with low-k materials.

### SUMMARY

In accordance with an aspect of the invention, a system is provided for electropolishing of a conductive surface of a wafer using a solution. The system includes a wafer holder to hold the wafer. An electropolishing pad includes an electrode layer with a first surface and a second surface, and a pad material layer attached to the first surface of the electrode layer. The pad material layer includes openings permitting the solution to wet both the conductive surface of the wafer and the first surface of the electrode layer. The system also includes a showerhead for applying fluid toward the second surface of the electrode layer.

In accordance with another aspect of the invention, a system is provided for electropolishing a conductive surface of a wafer using a solution. The system includes a wafer holder to hold the wafer and an electropolishing pad. The electropolishing pad includes a pad material layer and an electrode layer attached to the pad material layer. The pad material layer includes openings permitting the solution to wet both the conductive surface of the wafer and the electrode layer. At least one wafer contact is attached to the electropolishing pad while being substantially electrically isolated from the electrode layer. The wafer contact establishes electrical connection with the conductive surface of the wafer during electropolishing.

### BRIEF DESCRIPTION OF THE DRAWINGS

FIG. 1 is a schematic illustration of a copper plated substrate;

FIG. 2 is an embodiment of an electropolishing system according to an embodiment;

FIGS. 3A-3B are schematic illustrations of top views of exemplary electropolishing pads used with the system shown in FIG. 2;

FIG. 4 is a detailed schematic illustration of the electropolishing pad of the system shown in FIG. 2;

FIGS. 5-6 are schematic illustrations of electropolishing pads including multiple electrodes;

FIGS. 7A-7C are schematic illustrations of electropolishing systems using a belt shaped electropolishing pad and showerhead of an embodiment;

FIGS. 8A-8C are schematic illustrations of an embodiment of an electropolishing system using a belt pad with a showerhead;

FIGS. 9A-9B are schematic illustrations of an embodiment of surface contacts used with the electropolishing system;

FIG. 10 is a schematic illustration of an exemplary electropolishing pad with a predetermined opening pattern;

FIG. 11 is a schematic illustration of a belt electropolishing pad with embedded surface contacts which are configured as two spaced conductive strips oriented parallel to the direction of the lateral motion of the electropolishing pad;

FIGS. 12A-12C are schematic illustrations of various embodiments of connecting surface contacts and an electrode layer to a power supply, using contact elements;

FIG. 13 a schematic illustration of a belt electropolishing pad with an embedded surface contact, which is configured as a conductive strip placed in the electropolishing pad;

FIG. 14 is a schematic illustration of an embodiment of the electropolishing pad including an embedded surface contact; and

FIG. 15 is a substrate processed with the electropolishing system of an embodiment.

### DETAILED DESCRIPTION

As will be described in more detail below, the present invention provides a method and a system to electropolish or electroetch, or electrochemically mechanically polish a conductive material layer deposited on a surface of a substrate, such as a semiconductor wafer. The process of according to an embodiment performs electropolishing on a conductive material using an applied potential and a polishing or electropolishing pad that physically contacts the conductive surface of the substrate during at least part of the process time.

The process achieves the electrochemical and mechanical polishing and removal of the conductive material through the use of the electropolishing pad, according to an embodiment. The electropolishing pad comprises at least one electrode to achieve the electrochemical process on the conductive surface in the presence of a process solution. A pad layer with openings is placed on the electrode and prevents the electrode from touching the conductive surface of the wafer while mechanically assisting the removal process.

The electropolishing pad may be formed as a belt supported by a fluid cushion as it moves during processing. Alternatively, the electropolishing pad may be a standard pad supported by a solid platform. In the case of a standard pad, the pad preferably does not move during processing and it may or may not be attached to the solid platform. If the electropolishing pad is shaped as a belt that may move linearly in a unidirectional or bi-directional fashion, fluid pressure, such as air pressure, may be applied to a back surface of the electropolishing pad to push the polishing surface of the pad towards the conductive surface of the wafer as the pad is moved.

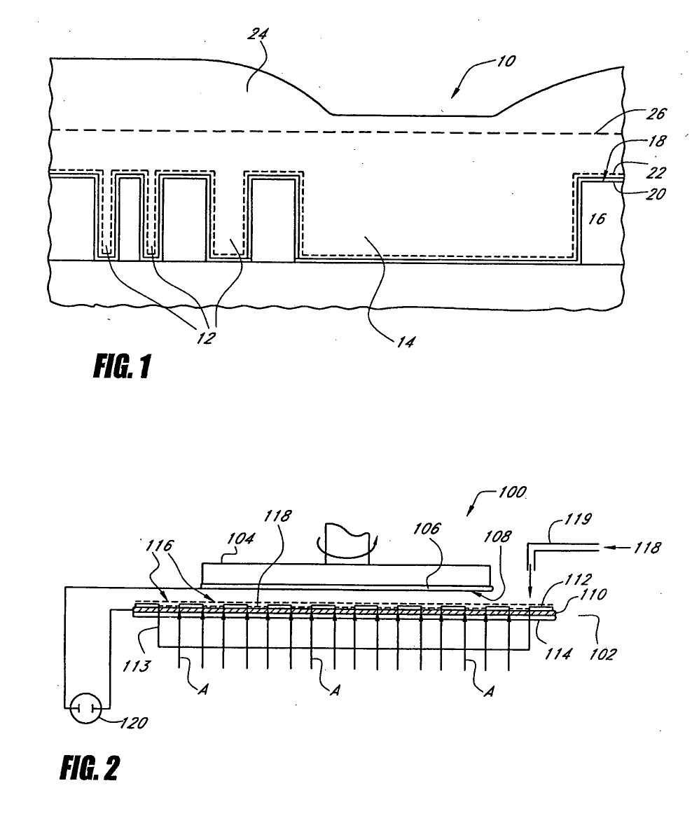

Reference will now be made to the drawings wherein like numerals refer to like parts. FIG. 2 illustrates an electropolishing system 100 of the present invention. The system 100 comprises an electropolishing pad 102 and a carrier 104 for holding a wafer 106 with surface 108 to be electropolished using the system 100. In this embodiment, the surface 108 of the wafer 106 may include an electroplated conductive layer, such as the non-planar layer 24 or the planar layer 26 shown in FIG. 1. The carrier 104 may rotate and move the wafer 106 vertically, and laterally in a linear and/or orbital motion.

The copper or conductive layer on the wafer surface 108 may be a planar or non-planar layer, depending on the deposition process used. For example, an electrochemical mechanical deposition process (ECMD) yields planar copper deposits on wafer surfaces comprising cavities, as discussed above. An electrochemical deposition process (ECD) yields generally non-planar copper deposits over large cavities, as shown in FIG. 1. If the copper layer is non-planar, the electrochemical mechanical polishing or planarization approach of certain embodiments has the capability to planarize the copper layer as it removes the unwanted excess portion from the wafer surface 108.

The electropolishing pad 102 is the part of the system 100 that allows performance of electrochemical and mechanical polishing on the surface 108 of the wafer 106. The electropolishing pad 102 may comprise an electrode 110 and a polishing layer 112 positioned on top of the electrode 110. Optionally, an insulating layer 114 may be positioned under the electrode 110 to electrically insulate it from other system components. The insulating layer 114 may be formed of a flexible insulating material, such as a polymeric material.

In the embodiment of the system 100 shown in FIG. 2, a support plate 113 supports the electropolishing pad 102. The support plate 113 may be formed of any material that has resistance to the chemical environment of the system 100, including, but not limited to, a hard polymer, stainless steel, etc. As will be described more fully below, the electropolishing pad 102 may move together with the support plate 113, or a relative motion may be established between the electropolishing pad 102 and the support plate 113, using a moving mechanism. In the latter case, the electropolishing pad 102 may be shaped as a belt electropolishing pad.

The electrode 110 may be made of a conductor, such as metal, and is preferably shaped as a flexible and thin conductive plate or film. For example, webs of stainless steel, brass, copper, etc may be used as the electrode 110. The electrode 110 may also be graphite or a conductive polymer layer, or a layer coated with a conductive material. The electrode plate may be continuous, made of a single piece, or discontinuous comprising multiple pieces. In this embodiment, the polishing layer 112 is made of a polishing pad material, such as polymeric or fixed abrasive CMP polishing pad materials supplied by polishing pad manufacturers, such as 3M of St. Paul, Minn., MIPOX International Corp. of Hayward, Calif. and Rodel, Inc of Phoenix, Ariz. The polishing layer 112 may include openings 116, which expose portions of the surface of the electrode 110 under it. Therefore, a process solution 118, filling the openings 116, wets or contacts the exposed portions of the electrode 110. The process solution 118 is preferably delivered onto the electropolishing pad 102 through a solution line 119, or multiple solution lines which are connected to a process solution supply tank (not shown).

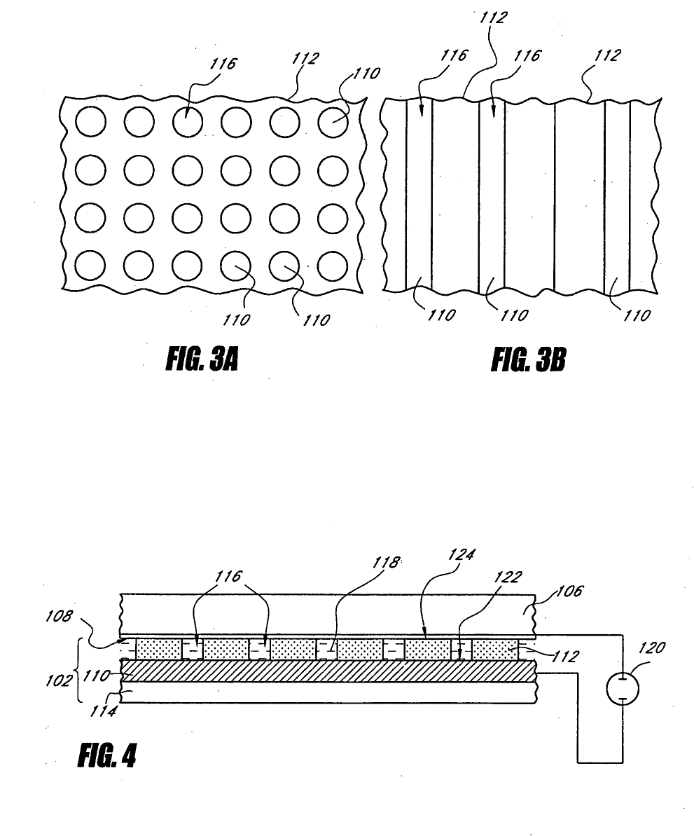

As shown in FIGS. 3A and 3B, openings 116 of polishing layer 112 may be shaped as holes or slits. Holes may have any geometrical form such as round, oval, square, or others. Similarly, slits may be continuous or discontinuous, uniform or non-uniform width, parallel or non-parallel to each other. It will be understood that the slits may be formed as straight walled slits or slanted walled slits as well. The openings 116 may be formed in a staggered manner across the polishing pad 102 to enhance electropolishing uniformity. Examples of such pads can be found in U.S Pat. No. 6,413,388, entitled Pad Designs and Structures For a Versatile Materials Processing Apparatus, and co-pending U.S. patent application Ser. No. 09/960,236, entitled Mask Plate Design, filed on Sep. 20, 2001 which are owned by the assignee of the present invention and hereby incorporated herein by reference in their entireties.

According to certain embodiments, the polishing layer 112 may be made of a porous material layer which may or may not include openings. In this case, the porous polishing layer is saturated with an electropolishing solution and keeps the solution between the wafer surface 108 and the electrode 110. When delivered to the polishing layer, the process solution 118 forms pools of process solution 118 contacting the electrode 110. The thickness of the pad may vary between 4 mils to 400 mils. The polishing layer 112 may actually be a multi-layer structure, including a polishing layer at the top facing the wafer 106. Under the polishing layer there may be other sub-layer or layers comprising soft and spongy materials. One such pad structure especially suited for processing wafers with ultra low-k dielectric layers is disclosed in U.S patent application Ser. No. 10/155,828, entitled Low Force Electrochemical Mechanical Deposition Method and Apparatus, filed May 23, 2002, which is owned by assignee of the present invention and hereby incorporated herein by reference in its entirety.

Referring back to FIG. 2, the electrode 110 and the surface 108 of the wafer 106 are connected to the terminals of a power supply 120. In an embodiment, as the surface 108 of the wafer 106 is lowered to contact the process solution 118, a potential difference is applied between the conductive substrate surface 108 and the electrode 110 by the power supply 120. During processing, the wafer 106 is preferably rotated and laterally moved as the surface 108 of the wafer 106 physically contacts the polishing layer 112, which has a polishing top surface, and the process solution 118, which is in contact with the electrode 110. As the potential difference is applied between the surface 108 and the electrode 110 during at least part of the processing period, electropolishing is performed on the surface 108 of the wafer 106.

It will be understood that, in this application, electropolishing is described as a process, including anodizing the substrate or wafer surface 108 and then mechanically polishing to remove at least part of the anodized surface layer, which may comprise passivating materials, such as oxides and/or other compounds, thereby removing the material from the substrate surface 108. Anodization of the surface 108 is achieved by making the surface 108 more anodic with respect to the electrode 110 as the potential difference is applied between the electrode 110 and the conductive surface 108. It is possible to apply DC voltage, variable voltage, or pulsed voltage, including reverse pulse voltage during the process.

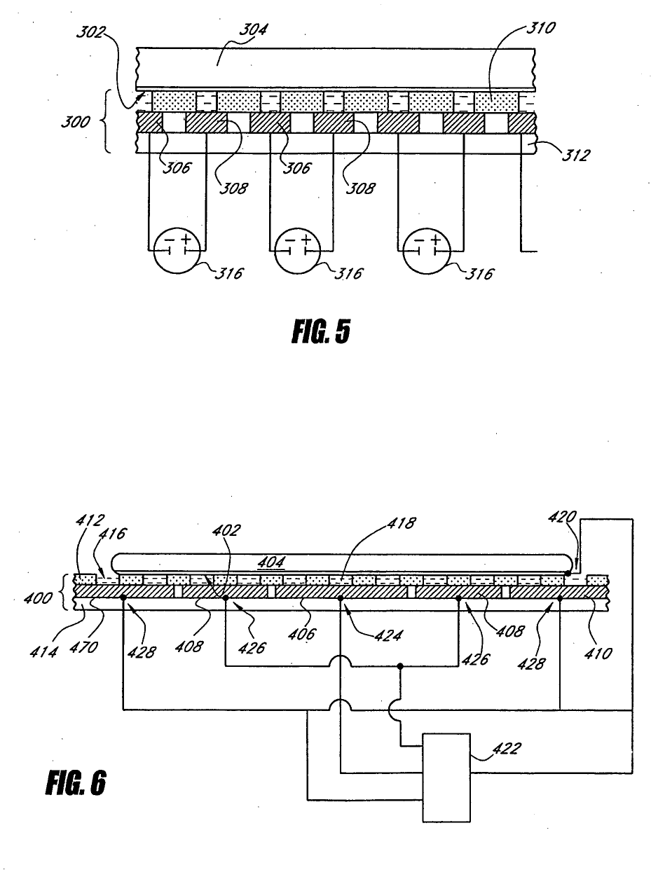

FIG. 4 illustrates a detailed view of a portion of the electropolishing pad 102, as it is applied to the wafer surface 108 during the electropolishing process. Conductive surface regions 122 of the electrode 110 are exposed by the openings 116 in the polishing layer 112. These exposed surface regions will be referred to as active surfaces 122 of the electrode 110. The process solution 118 fills the openings 116 and establishes contact both with the active surfaces 122 and the surface 108 of the wafer 106. When a potential is applied between the surface 108 of the wafer 106 and the electrode 110, process current passes through the process solution 118 filling the openings 116 between the active surfaces 122 of the electrode 110 and the surface 108 of the wafer 106. An upper surface 124 of the polishing layer 112 may or may not contain abrasive material. The upper surface 124 of the polishing layer 112 preferably touches or sweeps the surface 108 of the wafer 106 at least for a period of time during the electropolishing process.

As described above, during the electropolishing process, applied potential difference between the electrode 110 and the conductive surface 108 of the wafer 106 in the presence of the electropolishing solution 118 causes electrochemical oxidation or anodization of the surface 108, which is simultaneously polished with the electropolishing pad 102 to remove the oxidized, anodized or passivated layer from the top surface 108 of the wafer 106 touching the pad 102. The cavity regions that are not touched by the pad 102 contain the passivation layer formed by the solution 118 and electric field, which slows down material removal from such regions. Faster material removal from the swept areas compared to un-swept cavities planarizes the structure, such as the non-planar conductive layer 24 shown in FIG. 1. The process solution 118 may be a slurry containing abrasive particles, e.g. 0.1-5 weight percent alumina, ceria or silica particles, to assist in the efficient removal of the surface oxide or passivation layer.

It will be appreciated that each embodiment utilizes an electrode 110 structure in the electropolishing pad 102. Portions of the electrode 110 structure exposed through the openings 116 in the polishing layer 112 comprise active surfaces 122 of the electrode 110. Although in the described embodiments these exposed portions 122 are shown as substantially flat surfaces, they may be configured in many shapes and sizes, such as brushes, rods, beads that are placed in the polishing layer openings, as long as their height does not exceed beyond the upper surface 124 of the polishing layer 112, causing them to physically touch the surface 108 of the wafer 106. Examples of various electrode designs used in electrochemical mechanical processes are found in U.S. patent application Ser. No. 10/391,924, filed on Mar. 18, 2003, entitled Electroetching System and Process, which is owned by the assignee of the present invention and is hereby incorporated herein by reference in its entirety.

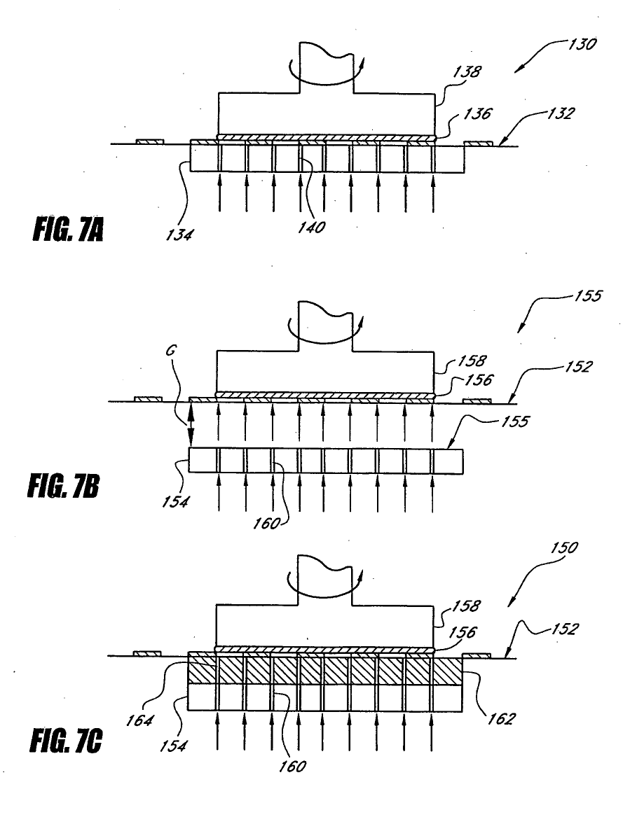

FIGS. 5 and 6 illustrate various embodiments of the electropolishing pad, which may be designed as a belt electropolishing pad that moves during processing or an electropolishing pad which may be fixed on a support plate. For example, FIG. 5 illustrates an embodiment of an electropolishing pad 300 that is in contact with a surface 302 of a wafer 304. The electropolishing pad 300 comprises an electrode layer comprising cathode electrodes 306 and anode electrodes 308, which are paired and isolated from one another, and positioned between a polishing layer 310 and an insulating layer 312. In this embodiment, the insulating layer 312 also fills the space between the electrodes 306, 308 to electrically isolate them from one another. Openings of the polishing layer 310 exposes cathode and anode electrodes 306 and 308 and are filled with a process solution which is prefereably dispensed over the electropolishing pad 300. The anodic current to the surface 302 of the wafer 304 is provided through the process solution touching an anode electrode 308 and leaves the surface through the process solution touching a cathode electrode 306. Each of such configured anode-cathode pairs is connected to at least one power supply 316 to apply an electropolishing potential between them during the process.

FIG. 6 illustrates another embodiment of an electropolishing pad 400 that is in contact with a surface 402 of a wafer 404. The electropolishing pad 400 comprises an electrode layer that has multiple sections 406, 408 and 410 that are isolated from one another. The sections 406-410 are positioned between a polishing layer 412 and an insulating layer 414. The electrode sections 406-410 may be arranged in a concentric fashion around each other so that each section is responsible for the electropolishing of a corresponding concentric location on the surface 402 of the wafer 404. Such concentric locations on the surface 402 of the wafer 404 are edge and central regions of the wafer 404. Sectioned electrodes can be used to control material removal uniformity from the wafer surface 402. In this embodiment, the insulating layer 414 also fills the space between the electrode sections 406-410 to electrically isolate them from one another. The sectioned electrodes 406-410 are exposed by the openings 416 in the polishing layer 412, which are filled with a process solution 418 that is preferably dispensed on the pad 400. Electrical contact to the wafer surface 402 may be made using a surface contact 420 touching an edge region of the wafer 404. The surface contact 420 may be connected to a power supply unit 422 including a power control device. The surface contact 420 is configured to move with the wafer carrier or holder 104 (FIG. 2). Each electrode section 406-410 is also connected to the power supply unit 422 using electrode contacts 424, 426 and 428, respectively. The power unit 422 is able to provide variable current to each electrode during the process to control material removal uniformity from the wafer surface 402. The power unit 422 may comprise a single power supply or multiple power supplies, one or more for each section of the electrode layer.

As mentioned above, if the electropolishing pad is not designed as a moving belt, it may be attached to and fixed on a support plate. Alternatively, the pad may not be attached to the support plate, but may be simply supported by the plate. In both cases, the wafer is pressed against the electropolishing pad and preferably rotated and may be translated laterally during the process. In such designs, the support plate 113 (FIG. 2) along with the electropolishing pad may also be rotated and otherwise moved with respect to the wafer. Such processes are exemplified in U.S. Pat. No. 6,176,992, entitled “Method and apparatus for electro-chemical mechanical deposition” which is owned by the assignee of the present invention and hereby incorporated herein by reference in its entirety.

Depending on the system requirements, the support plate 113 may or may not provide fluid flow, particularly air flow, depicted with arrows ‘A’ in FIG. 2, under the electropolishing pad 102. As will be described more fully below, if the electropolishing pad is designed as a belt that moves with respect to the support plate, for example, air flow is preferably used to push the belt shaped electropolishing pad towards the surface of the wafer and minimize or eliminate any friction between the moving belt and the support plate 113. Alternatively, if airflow is not present and there is physical contact and relative motion between the belt shaped electropolishing pad and the support plate, a low friction material such as Teflon® may be used at the interface between the polishing pad and the support plate. It is also possible to apply force onto the back surface of the belt by placing it across from a fluid source and applying fluid flow from the fluid source to the under-side or back side of the belt shaped electropolishing pad. As will be described below, this fluid source is called a showerhead. A fixed gap is established between the showerhead and the belt shaped electropolishing pad and by flowing fluid, such as air, onto the backside of the belt shaped electropolishing pad, the belt shaped polishing pad is pushed or urged towards the wafer surface. One exemplary system using a showerhead to apply fluid on the back side of a polishing belt is described in U.S. patent application Ser. No. 10/761,877, filed on Jan. 21, 2004, entitled “Chemical Mechanical Polishing Method and Apparatus for Controlling Material Removal Profile” which is owned by the assignee of the present invention and hereby incorporated herein by reference in its entirety.

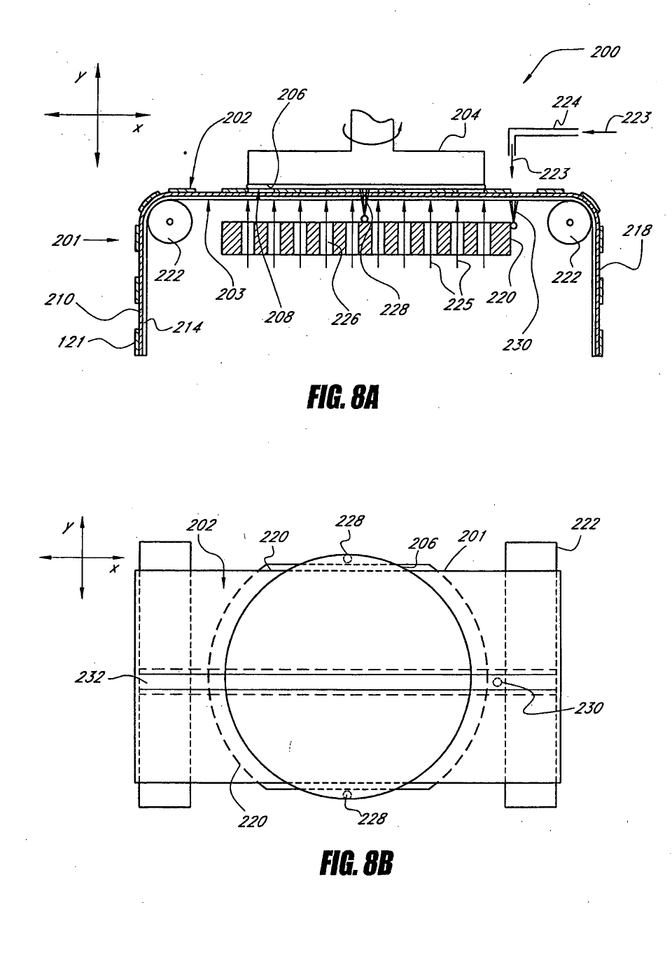

FIGS. 7A-7B exemplify systems using a belt shaped electropolishing pad or belt pad with either a support plate or a showerhead. In these systems, a relative motion is preferably established between the belt pad and the support plate or the showerhead. FIG. 7A illustrates an electropolishing system 130 using a belt pad 132 supported by a support plate 134. A wafer 136 to be electropolished is held by a wafer carrier 138. The belt pad 132 is moved linearly by a moving mechanism (not shown) on the support plate 134. In this system, to enable polishing action on the wafer 136, a relative motion can be established between the support plate 134 and the belt pad 132 whether or not a fluid flow, e.g., airflow, is provided through the support plate 134. As described above, airflow may be delivered to the backside of the belt pad 132 through the openings 140 in the support plate 134 while wafer surface is polished by the belt pad 132. Alternatively, the belt pad 132 may be kept motionless on the support plate 134, or may be secured on the support plate 134 by applying suction through the openings 140.

FIG. 7B illustrates another embodiment of an electropolishing system 150 using a belt pad 152 pushed by the airflow or fluid flow from a showerhead 154. The belt pad 152 is placed a fixed distance apart from a top surface 155 of the showerhead so that a gap ‘G’ is formed between the belt pad 152 and the showerhead 154. A wafer 156 to be electropolished is held by a wafer carrier 158. The belt pad 152 is preferably moved linearly by a moving mechanism (not shown) above the showerhead while the airflow is applied to the backside of the belt pad 152. In this system 150, to enable polishing action on the wafer 156, a relative motion can be established between the showerhead 154 and the belt pad 152 as the airflow is supplied to the gap ‘G’ through the showerhead 154. Airflow is delivered to the backside of the belt pad 152 through the openings 160 in showerhead 154 while the wafer surface is polished by the belt pad 152.

As illustrated in the embodiment shown in FIG. 7C, the top surface 155 of the showerhead 154 may include a buffer 162. The buffer 162 may be a compressible material layer or an inflatable bladder or the like filling the gap ‘G’. The buffer 162 enhances the polishing of the wafer surface as the wafer 156 is pressed on the belt pad 152 by the wafer carrier 158. The buffer 162 may have openings 164 corresponding to the openings 160 in the showerhead 154 so that in case fluid flow is utilized, the fluid can flow through the buffer 162 as well. If airflow or fluid flow is not utilized, force may be applied to the belt pad 152 by the buffer 162.

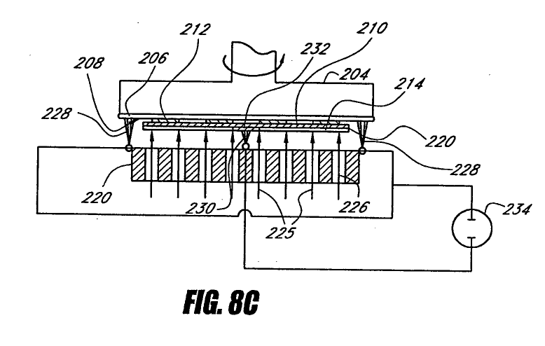

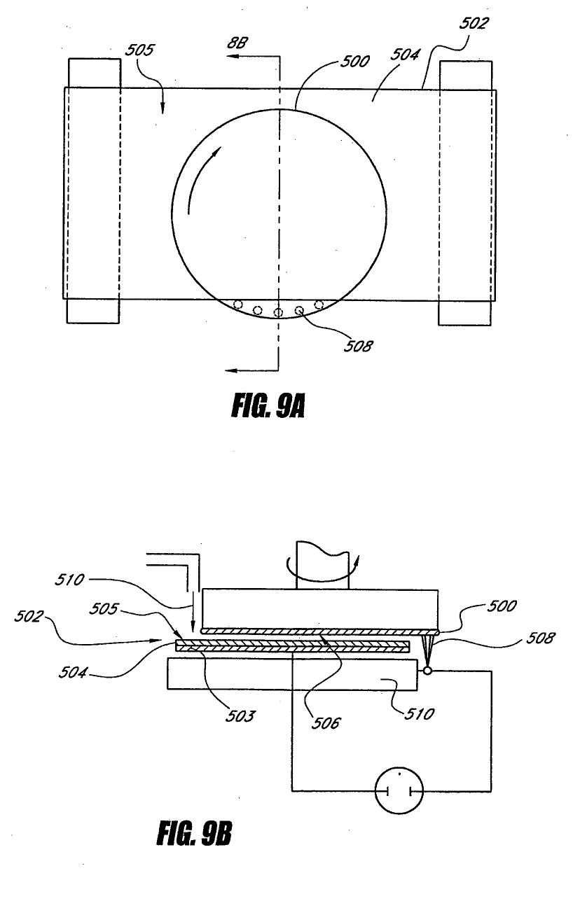

FIGS. 8A-14 exemplify various embodiments of the belt pad and showerhead combinations. Initially, the general system described in FIG. 7B will now be described more fully in connection with FIGS. 8A-8C. For clarity purposes, a new set of reference numerals will be used to describe FIGS. 8A-8C. FIGS. 8A-8C illustrate an electropolishing system 200 using a belt electropolishing pad 201 or belt pad. The belt pad 201 comprises a front surface 202 and a back surface 203. As shown in FIG. 8A, in a side view, the system 200 further comprises a wafer carrier 204 configured to hold a wafer 206 having a surface 208 to be processed. The surface 208 of the wafer 206 may comprise a conductive layer filling features, which is similar to the one shown in FIG. 1.

In this embodiment, the belt pad 201 comprises an electrode 210 or electrode layer, a polishing layer 212 and an optional insulating layer 214, which are all described in connection with FIGS. 2-4. It should be noted that the insulating layer may or may not be used. Openings in the polishing layer 212 expose active surfaces 218 of the electrode layer 210. Accordingly, in this embodiment, the polishing layer 212 and the active surfaces 218 of the electrode form the front surface 202 and the back side of the insulating layer 214 forms the back surface 203 of the belt pad 201. The belt pad 201 is positioned between the carrier head 204 and a showerhead 220, and supported and tensioned by support structures 222, such as rollers. The belt pad 201 is moved on the rollers 222 either in a unidirectional or bi-directional linear manner by a moving mechanism (not shown). The belt pad 201 may be dimensioned and shaped in various ways. Accordingly, the belt pad may be manufactured as a short belt pad section which can be moved bi-linearly, back and forth, by the moving mechanism. Alternatively, the belt pad may be manufactured as a long belt which is on a supply spool and extended between the supply spool and a take-up spool. After a certain process time, the belt pad is preferably advanced and wound on the take-up spool. In accordance with another embodiment, the belt pad may be manufactured as an endless loop.

A process solution 223 for electropolishing is preferably delivered to the belt pad 201 from a solution line 224. However, if the belt pad 201 moves in bi-directional or reverse-linear way, e.g., to the right and left in FIG. 8A, two solution lines are preferred so that one line is located at the right side of the wafer 206 and the other one is located at the left side of the wafer 206. Airflow 225 from the showerhead 220 is provided to urge the belt pad 201 against the surface 208 of the wafer 206. Air is flowed through holes 226 in the showerhead 220 and may be supplied from an air-supply unit (not shown). It should be noted that the showerhead 220 may comprise more than one flow zone and air flow may be provided at different rates at various zones. Therefore, pressure on the wafer surface 208 corresponding to the different zones may be varied for optimal removal rate control. Electrical connection to the surface 208 of the wafer 206 may be made using surface contacts 228 touching the edge of the surface 208 as the wafer 206 is moved, or a relative motion between the surface contacts 228 and the wafer surface 208 is provided.

Electrical connection to the electrode 210 may be made using electrode contacts 230. As will be described with reference to the FIGS. 8B-8C, electrode contacts 230 may either directly contact the moving electrode 210, preferably through an opening in the insulating layer if an insulating layer is employed in the belt pad structure, or indirectly by touching an extension piece attached to the electrode 210. In either case, a relative motion between the electrode 210 and the electrode contact 230 is provided. There would be no need for the electrode contact 230 to slide over the electrode 210 (i.e., no relative motion) if a contact 230 is attached to the electrode 210 away from the process area and it moves with the belt pad 210 back and forth in a bi-directional manner. Surface and electrode contacts 228, 230 may be made of conductive brushes, rollers, cylinders, wires, flexible foils or shims and the like.

In one embodiment, the electrical contacts 230 may be supported along the edge of the showerhead 220, although they may alternately be supported by other system components also. Of course, if the showerhead 220 is made of an electrically conductive material, the contacts 230 are electrically isolated from the body of the showerhead 220.

FIG. 8B is a top view of the belt pad 201 placed over the rollers 222, and the positions of the wafer 206 and the showerhead 220 are indicated. FIG. 8B also shows positions of the surface contacts 228 to the wafer 206 and electrode contact 230 to the belt pad 201. It should be noted that more than one electrical contact 230 to the belt pad 201 may be employed. Further, contact to the wafer 206 may be made at its front surface edge region or at its bevel or even at its back surface edge region if the conductive material on the surface 208 of the wafer 206 extends to the bevel or wraps around to the back edge region of the wafer 206. As shown in FIG. 8B, the diameter of the wafer 206 is larger than the width of the polishing belt 201, and therefore an exposed edge portion of the rotating conductive surface 208 of the wafer 206 is continuously contacted by the surface contacts 228. If electrical contact could be made at the back surface edge region of the wafer 206, then the width of the polishing belt 201 could be made larger than the diameter of the wafer 206.

As shown in FIGS. 8B-8C, in this embodiment, the surface contacts 228 are positioned along both sides of the belt pad 201 to touch the edge of the wafer 206 at both sides of the belt 201. This double side configuration of the surface contacts 228 will be referred to as double side surface contacts hereinbelow. An electrode contact 230 touches an electrode extension piece 232 shown as dotted strip to conduct electricity to the electrode 210. Alternatively, the insulating layer 214 may not be included in the structure of the belt pad 201, in which case substantially the whole backside surface of the electrode layer 210 facing the showerhead 220 is exposed. This makes the whole backside surface available for electrical connection at any point.

As shown in FIG. 8C in a front cross-sectional view, orthogonal to the view of FIG. 8A, the extension piece 232 is in contact with the electrode 210 and is placed in the insulating layer 214. The electrode contact 230 touches the extension piece 232 as the belt pad 201 is moved. As also shown in FIG. 8C, the double side surface contacts 228 touch the edge of the surface 208 of the wafer 206. Both the double side surface contacts 228 and the electrode contacts 230 are connected to a power supply 234 which applies a potential difference between them, and thus between the pad electrode 210 and the wafer surface 208.

It will be appreciated that certain embodiments of the present invention utilizes electrical contacts that deliver or receive the process current while the surface that they are touching is in motion or vice-versa. Examples of electrical contacts touching a surface or an edge region of a surface of a wafer during an electrochemical or an electrochemical mechanical process can be found in the following U.S. Patents and Published U.S. Applications, all of which are owned by the assignee of the present invention and hereby incorporated by reference herein in their entireties: U.S. Pat. No. 6,497,800 issued Dec. 24, 2002, entitled “Device Providing Electrical Contact to the Surface of a Semiconductor Workpiece During Metal Plating,” U.S. Pat. No. 6,482,307 issued Nov. 19, 2002, entitled “Method and Apparatus for Making Electrical Contact to Wafer Surface for Full-Face Electroplating or Electropolishing” (disclosing electrical contacts touching the surface of a wafer for full face electrochemical mechanical processing of the surface), U.S. Pat. No. 6,610,190 issued Aug. 26, 2003, entitled “Method and Apparatus For Electrodeposition of Uniform Film with Minimal Edge Exclusion on Substrate” (disclosing electrical contacts touching an edge region of a surface of a wafer for full face electrochemical mechanical processing of the surface), and U.S. Patent Application Publication No. 2003/0089598, entitled “Method and System to Provide Electrical Contacts for Electrotreating Processes” (disclosing various embodiments of electrical contacts).

Referring to FIGS. 8A-8C, in accordance with an exemplary electropolishing process of the surface 208 of the wafer 206, the wafer 206 is preferably rotated and optionally also laterally moved in proximity of the front surface 202 of the belt pad 201. The wafer surface 208 may be swept by the polishing layer 212 throughout the electropolishing process or for a period of time during the process while air flow is applied to the back surface 203 of the belt pad 201. The belt pad 201 is preferably moved linearly, as described above, while the electropolishing solution 223 is delivered onto it. An electropolishing potential is applied between the wafer surface 208 and the electrode 210 by the power source 234 to perform electropolishing of the wafer surface 208.

As exemplified above with reference to FIGS. 8A-8C, electrical connection to the wafer surface 208 is generally made through the double side surface contacts 228 touching the wafer surface 208 along the two edges of the long sides of the electropolishing pad or belt pad 201.

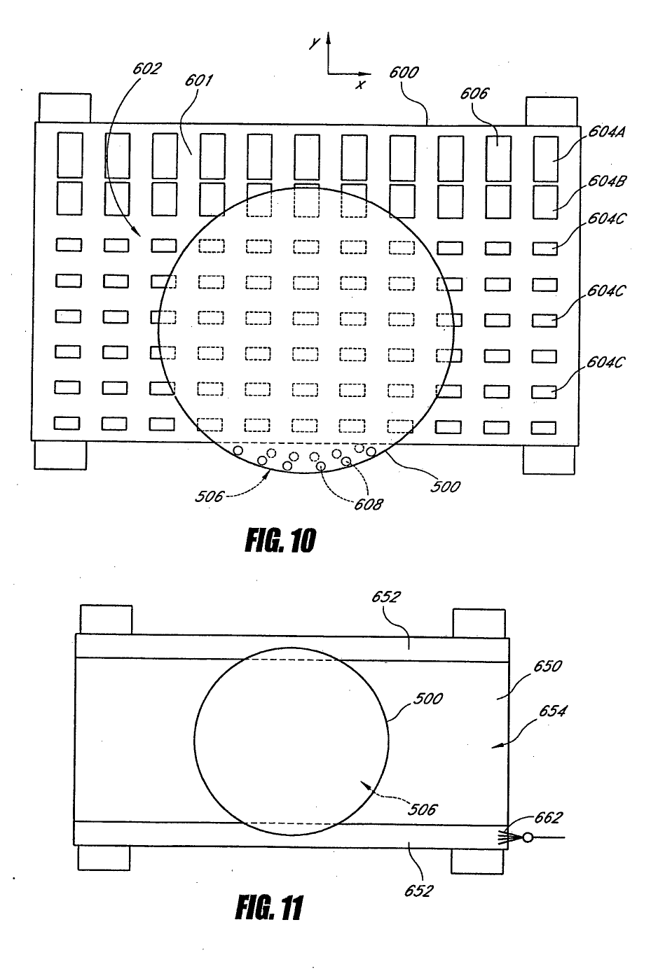

An alternative surface contact configuration will now be described with reference to FIGS. 9A-9B. FIGS. 9A-9B show, in top view and side view respectively, a wafer 500 held over a belt pad 502 having an electrode 503 and a polishing layer 504 with a polishing surface 505. A conductive surface 506 of the wafer 500 is electropolished as a process solution 510, for example an electropolishing solution, is delivered to the belt pad 502. The polishing layer 504 may be porous or may have openings that are not shown for the purpose of clarity in FIGS. 9A-9B. The process solution 510 fills the openings or pores of the polishing layer 504 and electrically connects the electrode 503 to the conductive surface 506 of the wafer 500 through the solution 510, which is conductive, during electropolishing.

Surface contact or contacts 508 are preferably located adjacent one side of the belt pad 502 so that they can touch the edge of the wafer surface 506 only at that side as the wafer 500 is rotated over the polishing layer 504 and the surface 506 is electropolished or planarized. This configuration of the surface contacts 508 will be referred to as single side surface contacts. As is well known in the field of electropolishing, the wafer surface 506 is made more anodic compared to the electrode 503 for electropolishing or planarization. The single side surface contact configuration of this embodiment may alleviate (compared to double side surface contact configuration) any small material removal differences between the edge region where the electrical contacts are made and the center/middle region of the rotating surface 506. Such difference may give rise to lower material removal rate at the edge region for the electropolishing process. The reason is that a more limited area touching the contacts 508 at the edge of the surface 506 intermittently leaves the process area on the polishing surface to be contacted by the side contacts 508, as compared to the embodiment of FIGS. 8A-8C. Therefore, that portion of the wafer surface 506 does not get processed during the brief period that it stays off the polishing surface. This may cause less material removal from the edge region in comparison to the center, which is always on the process area of the polishing layer and which is electropolished without interruption.

As described above, in one embodiment, the belt pad 502 may be released from a supply spool and picked up by a storage spool, or it may be an endless loop. In this embodiment, the belt pad 502 may be moved linearly in a unidirectional or bi-directional manner. As described in the previous embodiments, the belt pad 502 is placed over a showerhead 510, which may be made of a conductor or an insulator. Fluid flow from the showerhead 510 may be used to urge the belt pad 502 against the surface 506 of the wafer 500. The surface of the showerhead 510 may include a compressible layer, or a buffer layer if the belt pad 502 does not include one. Such compressible layers may also be used to urge the belt pad 502 towards the wafer surface at predetermined force. The electropolishing processing of the surface 506 occurs on a process area of the belt pad 502. The process area is the predetermined length of the polishing surface of the belt pad 502 that is used for processing of the wafers 500. After using the process area of the belt pad 502 for processing a predetermined number of wafers 500, the process area can be replaced by releasing unused belt portion from the supply spool while taking up the used portion over the storage spool.

The belt pad 502 may also be incrementally advanced during processing of the wafers 500. Pad conditioning may or may not be used on the polishing layer 504 of the pad 502. Alternatively, the process area may be the whole belt if a unidirectional linear motion is imparted to the belt, i.e. the belt pad 502 is in the form of a loop. In case the belt pad 502 moves in a bi-directional linear way, the portion of the belt pad 502 that makes contact with the wafer surface 506 defines the process area. As mentioned above, the polishing layer of the belt pad 502 may include openings or channels. The openings or channels may be configured into certain patterns to affect the material removal rate and removal profiles. Each predetermined process area length of the belt pad 502 may have the same opening pattern or different patterns affecting material removal rate. For example, a belt pad 502 having a first process area with a first pattern of openings removes copper with a first removal rate. Similarly, a second process area of the belt pad 502 with a second opening pattern removes the material with a second removal rate. The opening patterns also affect the removal profiles. Usually larger openings cause higher removal rates for more chemical processes. For more mechanical processes, the alternate may be true, i.e. areas with larger polishing layer sections may remove material at higher rate. Using certain patterns, one can control the removal profile and provide an edge high, a center high, or uniform removal profile.

In one embodiment of the present invention, the material removal difference between the edge and the center regions in a wafer may be alleviated or eliminated by controlling the size and shape of the openings in the belt pad, preferably openings with varying size and shape. The openings may be configured in various sizes and patterns, as described above. FIG. 10 illustrates a belt pad 600 including a polishing layer 601 with a polishing surface 602 having openings 604, which may expose the underlying electrode surface 606. In this embodiment, surface contacts 608 are in a single side contact configuration, i.e., located at one side of the belt pad 600 to establish electrical connection with an edge of the surface of the wafer 500. The wafer 500 is also held and rotated and may also be moved laterally by a small amount by a carrier head, which is omitted to simplify the figures.

The openings may have more than one-size such as first size openings 604A, second size openings 604B, and third size openings 604C, as shown in FIG. 10. In the illustrated embodiment, the first size openings 604A are the largest so they enable highest material removal. The second size openings 604B are made larger than the third size openings 604C to increase material removal from the edge of the surface of the wafer 500 during the electropolishing, to compensate for the amount that is not removed because of the above-explained discontinuous electropolishing of the edge region in which the contacts 608 touch the wafer 500. Material removal rate from the second openings 604B is higher than the third openings 604C. Accordingly, the polishing layer is such designed that the second size openings 604B are placed on the path of the edge of the rotating wafer surface. Furthermore, by moving the wafer in the y-direction as shown in FIG. 10, the edge of the wafer 500 may be exposed to even larger openings, i.e. first size openings 604A to further increase the removal rate at the wafer edge.

In this embodiment, control of material removal from the wafer surface is achieved by employing different size openings. As a result, a uniform electropolishing profile is obtained over the whole surface of the wafer 500 as the material is removed from the surface. It should be noted that the shapes and organization of the openings of the pad in FIG. 10 is only for describing the principles of the present invention. The openings, in this embodiment, may be formed in a staggered manner across the polishing pad to enhance electropolishing uniformity. Examples of such pad opening designs can be found in the above mentioned U.S. Pat. No. 6,413,388, entitled Pad Designs and Structures For a Versatile Materials Processing Apparatus and the co-pending U.S. patent application Ser. No. 09/960,236, entitled Mask Plate Design, filed on Sep. 20, 2001 which are owned by the assignee of the present invention and hereby incorporated herein by reference in their entireties. Openings for uniform processing may be in the form of holes, slits or other shapes. In this or in the following embodiments, use of a support plate, a showerhead or a polishing solution is similar to the embodiments described with respect to FIGS. 9A and 9B.

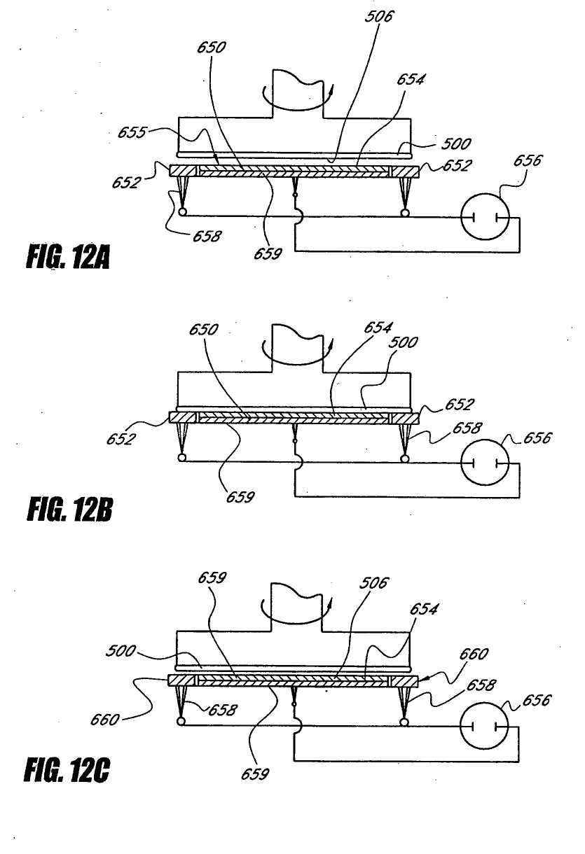

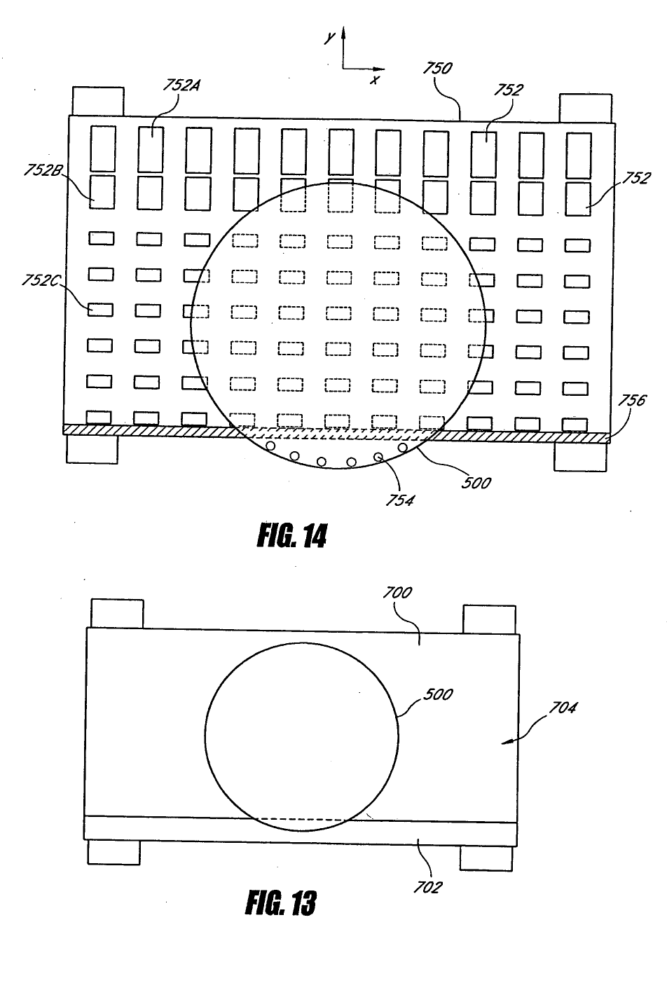

In the above embodiments, surface contacts to the wafer or substrate are generally secured on a system component next to belt pad. The surface contacts illustrated in the following embodiment overcome this limitation and are advantageously disposed in proximity of the polishing layer of the belt pad. As illustrated in FIG. 11, another embodiment of an exemplary belt pad 650 may have double-side embedded surface contacts 652 extending along both long sides of the polishing layer 654. The embedded surface contacts 652 may be made of thin flexible conductive strips attached along both sides of the belt pad 650, which are electrically isolated from the electrode 659 (FIG. 12A) of the belt pad 650. As illustrated in FIG. 12A, in side view, when the surface of the wafer 500 is brought in proximity of the polishing surface 655 of the polishing layer 654, the edge of the wafer 500 is partially located on the embedded surface contacts 652. As the wafer surface is placed on the polishing layer 654 as shown in FIG. 12B, the electrical connection between the embedded surface contacts 652 and a power supply 656 is established. The electrode 659 is also connected to the power supply 656. In FIGS. 12A-12C, openings in the polishing layer 654 are omitted to simplify the figures.

Contact members 658, such as conductive brushes, may be used to connect the surface contacts 652 to the power supply 656. Brushes 658 establish a physical and electrical connection between the embedded surface contacts 652 and the terminal power supply 656 during the electropolishing process. Alternatively, as exemplified in FIG. 11, electricity may be coupled to the embedded surface contacts 652, from the top using electrical contacts 662 such as fingers, rollers, brushes, pins and the like.

Referring back to FIG. 12A, with this surface contact configuration, when the surface 506 of the wafer 500 is placed in a predetermined distance away from the top surface of the polishing layer 654 of the belt pad, electrical connection between the edge of the surface of the wafer 500 and the embedded contacts 652 may be established through the process solution in between them. In this case, electrical connection between the embedded contacts 652 and the surface of the wafer 500 occurs without physically contacting the embedded surface contacts 652 and the surface of the wafer 500.

FIG. 12C shows another example of embedded surface contacts 660 that may be placed below the level of the top surface of the polishing layer 654 to establish electrical connection with the wafer surface through the process solution. In this embodiment, as the surface of the wafer 500 is polished by the polishing area, electrical connection to the conductive surface is provided through the process solution, which forms a meniscus between the embedded surface contacts 660 and the edge of the wafer surface 506. The structure can otherwise be similar to that of FIGS. 12A-12B, including electrical isolation between the two types of electrodes 659, 660 integrated into the belt pad 650.

In the embodiments described with reference to FIGS. 11-13, the belt pad may include openings, preferably with varying sizes optimized for uniform removal. Keeping the principles described in FIG. 10 in mind, larger openings may be placed along the path of the edge of the surface 506 of the wafer 500 to compensate material removal differences between the edge and center regions of the surface of the wafer 500.

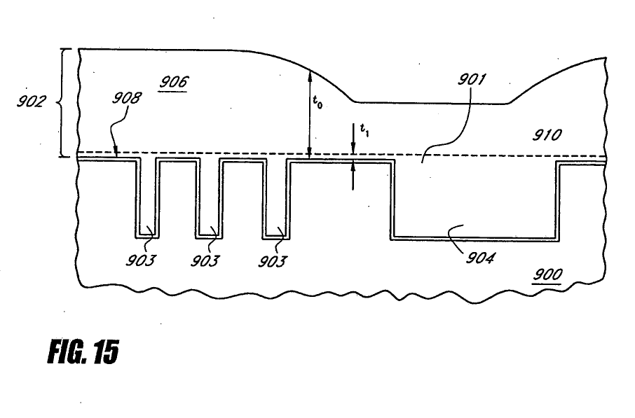

FIG. 13 illustrates an embodiment of a belt pad 700 having a single side embedded surface contact 702 located at one side of a polishing surface 704. In this embodiment, the embedded surface contact 702 functions the way embedded surface contacts 652 described above function, but the contact is at one side of the polishing pad. Alternatively, the approach described in FIG. 12C can be applied to the single side contact, and they may be placed below the level of the top surface of the polishing layer or polishing surface for electrical connection through the solution. During the process, by moving or scanning the wafer in y-direction, while still keeping at least a portion of the edge of the surface of the wafer 500 on the embedded surface contact 702 for electrical connection, the material removal from the edge region is increased.

FIG. 14 illustrates a hybrid structure of the embodiments described in connection to FIGS. 10 and 13. In this embodiment, the belt pad 750 comprises openings 752, such as 752A, 752B and 752C. Electrical connection to the surface of the wafer 500 maybe established using single side surface contacts 754 and single side embedded surface contact 756. During the process, the surface contacts 754 and embedded surface contact 756 can be used together or by themselves, depending on the motion of the wafer 500. For example, if the wafer 500 is moved in y-direction to expose the edge of the surface of the wafer 500 to the large openings 752A, only the embedded surface contact 756 can be used to establish electrical connection to the wafer surface. As described above in the previous embodiment, moving or scanning the wafer in y-direction, while still keeping at least a portion of the edge of the surface of the wafer 500 on the embedded surface contact 756 for electrical connection, the material removal from the edge region is further increased.

The above-described embodiments provide a material removal process comprising electrochemical mechanical polishing and chemical mechanical polishing, which can be performed in the same electrochemical mechanical processing module. This two-step process can be applied to the structure shown in FIG. 15. FIG. 15 shows a substrate 900 having a copper layer 901. An excess portion 902 of the copper layer 901 is removed using an embodiment of the process. The excess portion 902 may be a non-uniform layer, as shown in FIG. 15, or a planar layer, such as the planar layer 26 represented in FIG. 1. The substrate 900 comprises features 903 and 904 formed in it, as shown in FIG. 15. The substrate 900 may be a dielectric layer formed on a semiconductor wafer. The features 903 are high aspect ratio cavities, such as vias, and form a so-called high-density array. A high-density array is generally comprised of features, preferably high aspect ones, located densely on certain areas of the wafers. The feature 904 is a low aspect ratio large feature such as a trench. The features 903 and 904 and surface 906 of the substrate 900 may be coated with a barrier layer 908. A copper layer 901 is preferably formed on the barrier layer 908, filling the features 903, 904.

Referring to FIG. 15, in one embodiment, the process of this embodiment is performed using electrochemical mechanical polishing to reduce the thickness of the copper layer down to approximately 300 Å to 1,500 Å. The electrochemical mechanical polishing is performed by applying the belt pad described above while a potential difference is applied between the copper layer and an electrode. During the process, relative motion is established between the polishing pad layer of the belt pad and the copper layer 901 as a process solution, such as an electropolishing solution, is applied to the pad.

At a first stage of the process, an electrochemical mechanical process is applied at a high removal rate, such as a rate more than 4000 Å/minute, to planarize and reduce the thickness of the excess portion 902 to an 300 Å to 1,500 Å, as depicted with line 910 in FIG. 15. In other words, thickness t₀ of the excess portion 902 is reduced to t₁ which is approximately equal to 1000 Å. At this point, an applied potential between the copper layer 901 and the electrode is interrupted and the material removal is continued in chemical mechanical polishing (CMP) process mode by having a relative motion between the remaining copper surface 901 and the polishing pad layer in the same module and using the same electropolishing solution. The CMP process is preferably applied at a low material removal rate, (less than 4,000 Å) such as a rate at a range between 2000 to 4000 Å/minute. The CMP process preferably continues until the copper is cleared from top of the high-density regions having features 903 without dishing the copper in large features 904. Alternatively, at this step, a CMP solution may be used to fine-polish the copper.

Although various preferred embodiments and the best mode have been described in detail above, those skilled in the art will readily appreciate that many modifications of the exemplary embodiment are possible without materially departing from the novel teachings and advantages of this invention.

1. A system for electropolishing a conductive surface of a wafer using a solution, comprising:
a wafer holder to hold the wafer;
an electropolishing pad including an electrode layer with a first surface and a second surface, a pad material layer attached to the first surface of the electrode layer, the pad material layer including openings permitting the solution to wet both the conductive surface of the wafer and the first surface of the electrode layer; and
a showerhead for applying fluid towards the second surface of the electrode layer.

2. The system of claim 1, further comprising at least one surface contact to connect the conductive surface of the wafer to a power supply.

3. The system of claim 2, wherein the at least one surface contact comprises conductive strips attached to the electropolishing pad.

4. The system of claim 3, wherein the conductive strips are oriented substantially parallel to a direction of lateral motion of the electropolishing pad.

5. The system of claim 2, wherein the at least one surface contact is attached to the electropolishing pad.

6. The system of claim 5, wherein the at least one surface contact is disposed along an edge region of the electropolishing pad to touch the edge of the conductive surface of the wafer.

7. The system of claim 2, wherein the at least one surface contact is positioned outside the electropolishing pad and configured to contact an edge region of the conductive surface of the wafer to maintain electrical contact when a relative motion is established between the wafer and the at least one surface contact.

8. The system of claim 7, wherein the openings of the pad material layer become smaller as the openings get closer to the surface contact.

9. The system of claim 7, wherein the electropolishing pad comprises a belt, and the openings comprise small openings on a side of the electropolishing belt proximate the surface contact and larger openings on a side of the electropolishing belt distal to the surface contact, a size of the openings corresponding to a distance from the surface contact.

10. The system of claim 1, wherein the electropolishing pad is placed on a surface of the showerhead.

11. The system of claim 1, wherein a gap is formed between a surface of showerhead and a bottom surface of electropolishing pad.

12. The system of claim 1, wherein a top surface of the showerhead includes a compressible layer.

13. The system of claim 1, wherein the electropolishing pad is a belt pad extending between a supply spool and a take-up spool.

14. The system of claim 13, further comprising a moving mechanism configured to move the belt pad linearly in a unidirectional or bidirectional manner during electropolishing.

15. The system of claim 1, wherein the wafer holder is configured to move in a bidirectional manner while the electropolishing pad is kept stationary.

16. The system of claim 2, further comprising at least one contact member to electrically connect the electrode layer to the power supply.

17. The system of claim 16, wherein the at least one contact member is configured to have relative motion with respect to the electropolishing pad.

18. The system of claim 2, wherein the at least one surface contact is configured to move with the wafer holder.

19. The system of claim 1, further comprising a solution delivery mechanism to provide solution on the electropolishing pad.

20. The system of claim 1, wherein the solution is a slurry including abrasive particles.

21. The system of claim 1, wherein surface of the pad material includes abrasives.

22. A system for electropolishing a conductive surface of a wafer using a solution, comprising:
a wafer holder to hold the wafer;
an electropolishing pad including a pad material layer and an electrode layer attached to the pad material layer, the pad material layer including openings permitting the solution to wet both the conductive surface of the wafer and the electrode layer; and
at least one wafer contact attached to the electropolishing pad while being substantially electrically isolated from the electrode layer, the wafer contact establishing electrical connection with the conductive surface of the wafer during electropolishing.

23. The system of claim 22, wherein the at least one wafer contact is disposed along at least one edge region of the electropolishing pad to touch an edge of the conductive surface of the wafer during electropolishing.

24. The system of claim 22, wherein the at least one wafer contact comprises two conductive strips attached to the electropolishing pad.

25. The system of claim 24, wherein the two conductive strips are placed substantially parallel to a direction of lateral motion of the electropolishing pad.

26. The system of claim 22, further comprising a showerhead.

27. The system of claim 26, wherein the electropolishing pad is placed on a surface of the showerhead.

28. The system of claim 26, wherein a gap is left between a surface of showerhead and a backside of the electropolishing pad.

29. The system of claim 22, wherein the electropolishing pad is disposed on a support plate.

30. The system of claim 22, wherein the electropolishing pad is a belt pad extending between a supply spool and a take-up spool.

31. The system of claim 30, further comprising a moving mechanism to move the belt pad linearly in a unidirectional or bidirectional manner.

32. The system of claim 22, wherein the wafer holder is configured to move in a bidirectional manner while the electropolishing pad is kept stationary.

33. The system of claim 22, wherein the at least one wafer contact and the electrode layer are connected to at least one power supply using contact members.

34. The system of claim 33, wherein the at least one wafer contact and the electrode layer are connected to opposite poles of the power supply to make the conductive surface of the wafer anodic relative to the electrode layer of the electropolishing pad.

35. The system of claim 33, wherein the contact members are configured to have relative motion with the at least one surface contact and the electrode layer.

36. The system of claim 22, wherein the at least one wafer contact is configured to be stationary with respect to the electropolishing pad.

37. The system of claim 22, wherein the solution is delivered onto the electropolishing pad by a solution delivery mechanism.

38. The system of claim 22, wherein the solution is slurry including abrasive particles.

39. The system of claim 22, wherein surface of the pad material includes abrasives.

40. The system of claim 22, wherein a top surface of the wafer contact is recessed relative to a polishing top surface of the pad material layer and electrical connection between the wafer contact and the conductive surface is maintained through the solution.
